(19) United States
(12) Patent Application Publication
(10) Pub. No.: US 2009/0168731 A1
(43) Pub. Date: Jul. 2, 2009

(54) METHOD AND APPARATUS FOR HANDLING INTERACTIONS BETWEEN MEASUREMENT GAP, AUTOMATED REPEAT REQUEST, DISCONTINUOUS RECEPTION AND DISCONTINUOUS TRANSMISSION IN WIRELESS COMMUNICATIONS

(75) Inventors: Guodong Zhang, Syosset, NY (US); Jin Wang, Central Islip, NY (US); Shankar Somasundaram, Deer Park, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/347,622

(22) Filed: Dec. 31, 2008

Related U.S. Application Data
(60) Provisional application No. 61/018,071, filed on Dec. 31, 2007.
(60) Provisional application No. 61/018,994, filed on Jan. 4, 2008.

(51) Int. Cl. H04J 3/00; H04W 72/00

(52) U.S. Cl. 370/336; 455/450

(57) ABSTRACT

A method and apparatus for handling interactions between measurement gap, automated repeat request, discontinuous reception and discontinuous transmission in wireless communications are disclosed. The method and apparatus are for real-time data and non-real time data in both an uplink and a downlink.

### CROSS REFERENCE TO RELATED APPLICATIONS

This application claims the benefit of U.S. provisional application Nos. 61/018,071, filed Dec. 31, 2007, and 61/018,994, filed Jan. 4, 2008, which are incorporated by reference as if fully set forth.

### FIELD OF INVENTION

This application is related to wireless communications.

### BACKGROUND

Wireless communication systems are now common. Communications standards are developed in order to provide global connectivity for wireless systems and to achieve performance goals in terms of, for example, throughput, latency and coverage. One current standard in widespread use, called Universal Mobile Telecommunications Systems (UMTS), was developed as part of Third Generation (3G) UMTS Radio Systems, and is maintained by the Third Generation Partnership Project (3GPP).

An example of a UMTS system architecture in accordance with 3GPP specifications is depicted in FIG. 1. The UMTS network architecture 10 includes a Core Network (CN) 15 interconnected with a UMTS Terrestrial Radio Access Network (UTRAN) 20 via an Iu interface 25. The UTRAN is configured to provide wireless uplink (UL) and downlink (DL) telecommunication services to users through wireless transmit receive units (WTRUs) 30, referred to as user equipments (UEs) in the 3GPP standard. Communication between UTRAN 20 and WTRUs 30 proceeds via a Uu radio interface 60. A commonly employed air interface defined in the UMTS standard is wideband code division multiple access (W-CDMA). The UTRAN 20 contains one or more radio network controllers (RNCs) 35 and one or more base stations 40, the latter referred to as Node B by 3GPP. The Node Bs which collectively provide for the geographic coverage for wireless communications with UEs 30. One or more Node Bs 40 is connected to each RNC 35 via an Iub interface 45; RNCs within a UTRAN 20 communicate via an Iur interface 50.

In general, wireless communication system components are configured with a physical layer, commonly called layer 1 or PHY, for the physical transmission and reception of wireless signals. The PHY layer, in turn, is directly controlled by a Medium Access Control layer (MAC), commonly called layer 2 which in turn processes data to and from various higher layers. In some configurations, such as proposed in 3GPP Long Term Evolution (3GPP LTE) systems, the MAC coordinates measurements from local PHY layers regarding local status and conditions to enable control of local PHY modulation and configuration settings. MAC measurements also support downlink scheduling rates and radio conditions at the WTRU.

In a 3GPP LTE active state, an enhanced Node B (eNB) provides measurement gaps in the scheduling for a UE. The gap provides the UE sufficient time to change frequency, make a measurement, and switch back to an active channel.

A commonly assigned measurement gap has a duration of 20 ms. When there is ongoing DL persistently-scheduled service traffic, the WTRU may be configured to first evaluate whether 20 ms intervals are sufficient to perform measurements that support inter-frequency and inter-radio access technology (RAT) mobility. If 20 ms is sufficient, the WTRU may report to the eNB and the eNB may determine whether to use the available 20 ms intervals or to assign new measurement gaps.

If 20 ms is not sufficient, or the WTRU is unable to use multiple 20 ms intervals to perform measurements, the eNB can estimate when the DL persistently-scheduled service traffic will finish. If there is no indication that the persistently-scheduled service will finish in a relatively short time, the eNB can allocate the measurement gaps to the WTRU. If the measurement gaps are allocated when DL persistently-scheduled service traffic is on-going, the WTRU may experience DL voice interruptions.

When a measurement gap has been assigned for a WTRU, the WTRU may not receive any DL traffic from the eNB during the measurement gap except when performing inter-frequency and inter-RAT measurement for mobility purposes.

In some configurations in 3GPP LTE systems, a WTRU can process both hybrid automated repeat requests (HARQ) and also use discontinuous reception (DRX) and discontinuous transmission (DTX). HARQ is a common method of error correction. A WTRU employing DRX goes into an off-state when it does not have to receive and switches to an on-state only when necessary to receive information. DTX is the corresponding operation involving transmission. Use of DTX and DRX can reduce energy consumption by the WTRU and extend battery charge time. DTX/DRX may be periodic, in which the WTRU switches between on-state and off-state at a frequency which is at least momentarily fixed. The frequency and the durations of the on-state and the off-state may be varied by signaling the WTRU. In a WTRU, DTX in the uplink and DRX in the downlink may be used in combination, and the frequencies of the DTX and DRX cycles may be linked to each other. In this case, the two cycles may be referred to collectively as DTX/DRX.

It is desirable to selectively control the WTRU during a measurement gap, when HARQ communications and DTX/DRX communications may coexist either in uplink (UL) or downlink (DL) communications. In particular, it would be desirable to control a wireless transmit receive unit (WTRU) when a measurement gap, a HARQ signal, and DRX and DTX signals coexist, both in real time (RT) service using persistent scheduling, and in non-real time (NRT) service, using semi-persistent or periodic scheduling.

### SUMMARY

A method and apparatus for handling interactions between measurement gap, automated repeat request, discontinuous reception and discontinuous transmission in wireless communications are disclosed for real-time data and non-real time data in both an uplink and a downlink.

### BRIEF DESCRIPTION OF THE DRAWINGS

A more detailed understanding may be had from the following description, given by way of example in conjunction with the accompanying drawings wherein:

FIG. 1 is a block diagram of an overview of the system architecture of a conventional UMTS network;

FIGS. 2A and 2B are a block flow diagram illustrating interaction between measurement gap, HARQ and DRX in downlink (UL) operations of a WTRU in accordance with one embodiment;

FIGS. 3A and 3B are a block flow diagram illustrating interaction between measurement gap, HARQ and DRX in uplink (DL) operations of a WTRU in accordance with one embodiment;

FIG. 4 shows an embodiment of an architecture of a medium access control (MAC) entity; and

FIG. 5 shows an embodiment of a wireless transmit/receive unit including a MAC entity.

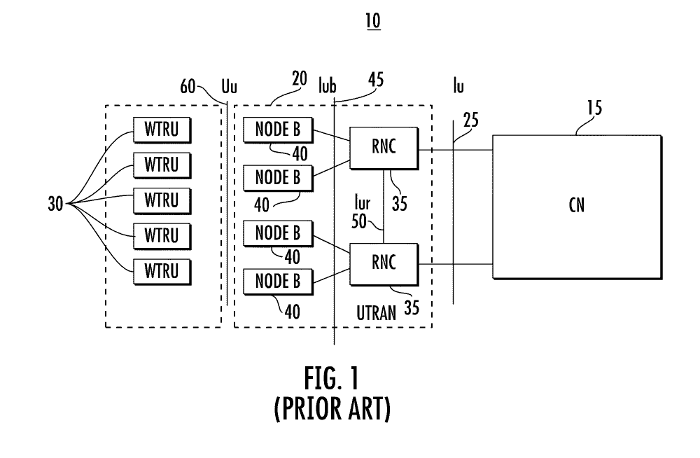

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

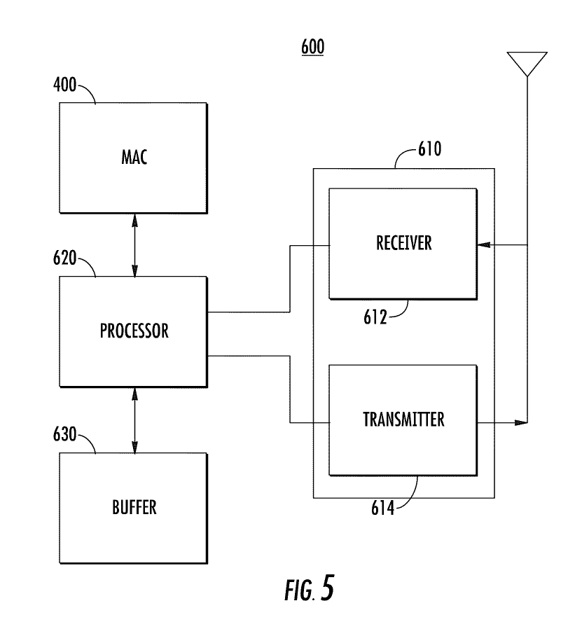

Although the examples below are provided in the context of a 3GPP LTE (Long Term Evolution) system, this is not intended to be limiting to any such specific system. FIG. 5 shows an embodiment of a wireless transmit/receive unit (WTRU) 600 that may include a transceiver 610 configured to transmit and receive wireless communication signals for real time (RT) services, such as voice or video, and non-real time (NRT) services such as data packets on the Internet. Transceiver 610 may include a receiver 612 and a transmitter 614. The WTRU may also include a processor 620 configured to control the transceiver to perform the functions described. The processor may be configured to control hybrid automated repeat request (HARQ) signaling and discontinuous reception (DRX) and discontinuous transmission (DTX) signaling by the transceiver. The processor may be configured to control the transceiver with respect to measurement gaps when only limited signaling related to measurements is permitted and to apply different control rules for real time (RT) and non-real time (NRT) services with respect to HARQ signaling and DRX and DTX signaling by the transceiver when a measurement gap is not in effect. The transceiver may implement physical layer functions and the processor may implement MAC layer functions to enable the WTRU to be used in a selected wireless communication network such as a 3GPP LTE network. MAC layer functions may be carried out by a MAC entity 400, described in detail below. The WTRU 600 may also contain a buffer 630 for storing data to be transmitted by the WTRU.

A method for handling interactions between measurement gaps, HARQ, and DTX/DRX in a WTRU for downlink operations is now described. Before a measurement gap is assigned, the WTRU may be configured to determine if there is active downlink (DL) traffic. If there is no downlink traffic, a measurement gap can be allocated by an enhanced Node B (eNB) based on a WTRU's status or a WTRU request, since there are no interaction issues to consider.

When there is ongoing DL NRT traffic, the start of a measurement gap can be allocated after ongoing NRT traffic ends, which may be after the eNB either receives an acknowledgement (ACK) from the WTRU or transmits a maximum number of HARQ retransmissions.

While the WTRU is in a measurement gap, there cannot be any DL traffic from the Node B so there are no DTX/DRX/HARQ interactions. Alternatively, after each measurement gap ends, a method may be used as set forth below to handle interaction between the measurement gap and HARQ.

If there are unfinished HARQ processes in the DL before the start of a measurement gap, the WTRU may process the HARQ processes while taking the upcoming measurement gap into consideration. The WTRU may do this by beginning the process a number k of transmission time intervals (TTIs) before the start of the gap, where k≧0. The value of k is a design parameter. The WTRU may be configured to process current HARQ operations for both RT and NRT services by at least one of the following alternatives.

In a first alternative the WTRU may save the HARQ data, which may include failed previous transmission data blocks and parameters such as a redundancy version. After the measurement gap, the WTRU may resume the interrupted HARQ operation. If the HARQ process retransmission occurs before the last TTI and before the start of the measurement gap (or the last TTI which allows the WTRU to decode the data block and transmit ACK/NACK before the start of the measurement gap), the HARQ processed will be decoded by the WTRU.

In a second alternative the WTRU may flush any buffered HARQ data and reset HARQ parameters immediately. This may be effective when the upcoming measurement gap is relatively long.

In a third alternative a timer is started and the WTRU may flush buffered HARQ data and reset HARQ parameters upon expiration of the timer. If the HARQ process is retransmitted between the starting and the expiration of the timer, the HARQ processed is decoded by the WTRU. Alternatives for handling HARQ/Measurement gap interactions are summarized in Table 1 below.

TABLE 1
SUMMARY OF HARQ/MEASUREMENT GAP INTERACTIONS IN DOWNLINK
At a predetermined number of TTIs before start of measurement gap:

| | | | | |
|---|---|---|---|---|
| 1. Save HARQ data | OR | Flush buffered HARQ | OR | 1. Start a timer |
| 2. Resume HARQ process | | data and reset HARQ | | 2. Flush buffered HARQ |
| after measurement gap ends | | parameters immediately | | data and reset HARQ data |
| | | | | when timer expires |

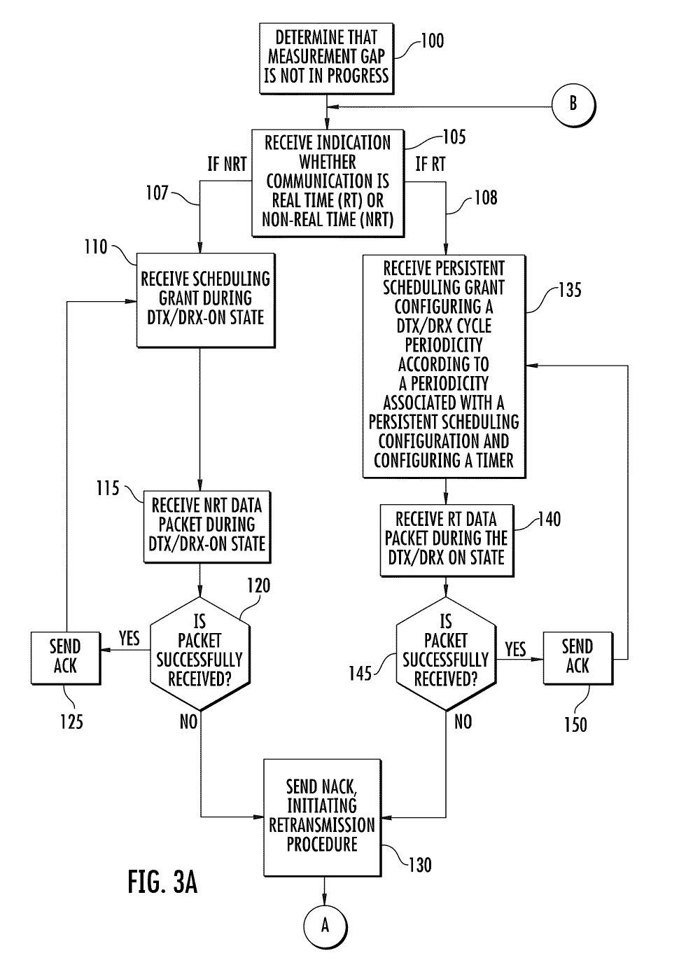

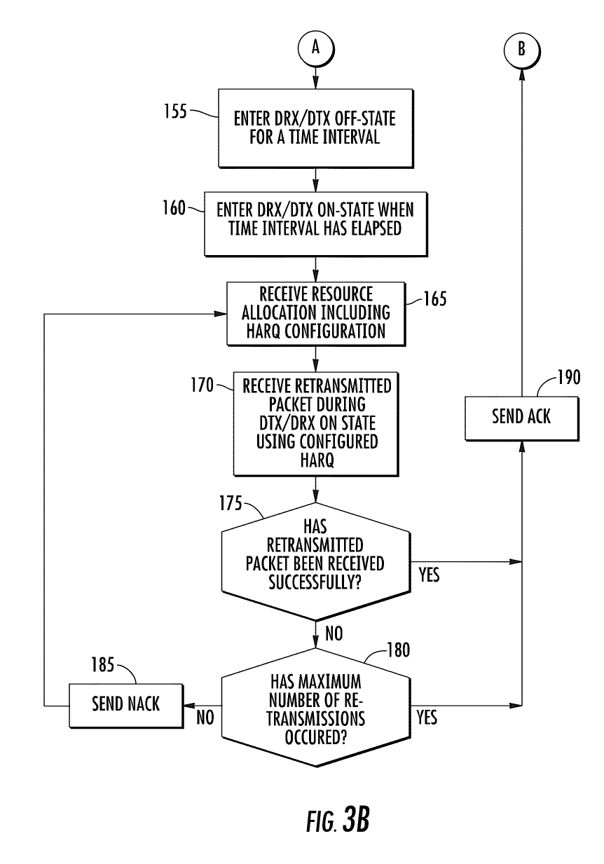

Next to be described is an embodiment of the method for handling interactions between HARQ and discontinuous reception (DRX) or discontinuous transmission (DTX) in the downlink in the absence of a measurement gap. This embodiment is shown in FIGS. 3A and 3B. In FIG. 3A the WTRU determines that a measurement gap is not in progress 100, as described above. The WTRU receives from a Node B an indication of whether the information it is about to receive is RT or NRT 105. For example, the WTRU may receive an indication that RT information is about to arrive (RT service) by detecting signaling on a physical downlink control channel (PDCCH) for persistent scheduling. This is shown in the right branch 108 in FIG. 3A. In this case, the WTRU may receive a DL persistent scheduling grant 135. Using information in the grant, the WTRU may configure its HARQ process for an initial DL RT data packet, configure its DRX, and configure one or more appropriate timers, such as an inactivity timer, a HARQ retransmission timer (HARQ RTT), and the like. The grant may configure the DRX periodicity according to a periodicity associated with the RT service. For example, the DRX periodicity may be configured to be locked to a periodicity associated with the persistent scheduling. An example of the latter is the 20 ms periodicity used with Voice over Internet Protocol (VoIP) service.

Once the WTRU is configured in response to a persistent scheduling grant, the WTRU may enter the DRX off-state. Then, during a later periodic DRX on-state, the WTRU may receive a DL RT data packet 140. The WTRU determines whether or not the packet has been successfully (correctly) received 145. If the packet has been successfully received the WTRU may send an acknowledgement (ACK) 150 to the Node B in the UL and wait for a new scheduling grant 135. At this point the WTRU may again enter the DRX off-state. If the WTRU detects that the packet has not been successfully received, or if the WTRU fails to decode the DL RT packet it may transmit a negative acknowledgement (NACK) to the Node B 130. This initiates a retransmission procedure, shown in FIG. 3B and described below.

The left branch of FIG. 3A shows the WTRU configured for NRT service 107. In this case, the WTRU may monitor the PDCCH during a DRX on-state for possible DL allocation 110. If the WTRU detects a DL scheduling grant from the PDCCH, the WTRU may configure the HARQ process according to parameters received from the PDCCH and prepare to receive data from an allocated physical resource. The WTRU may remain in the DRX on-state to receive a DL NRT packet 115. The WTRU determines if the NRT packet has been successfully received 120. If the DL NRT packet is received successfully, the WTRU may send an ACK in the UL to the Node B 125 and wait for a new scheduling grant 110. After the DRX inactivity timer expires, the WTRU may enter a short DRX cycle. If the WTRU fails to decode the DL NRT packet, the WTRU may send a NACK in the UL to the Node B 130. As in the case of RT data, sending the NACK initiates the retransmission procedure shown in FIG. 3B and described as follows.

After sending a NACK, the WTRU may remain in a DTX/DRX on-state. Alternatively, after sending the NACK, the WTRU may enter DTX/DRX off state lasting for a certain time interval 155, and re-enter a DTX/DRX on state at the end of the time interval 160. The time interval may be a number y of TTI'S, where y may be a minimum ACK/NACK transmission and processing delay. In either case, once the WTRU is in a DRX on-state 160, it may receive a resource allocation which includes HARQ configuration for retransmission 165.

The WTRU then may receive and process a retransmitted packet using the configured HARQ 170. The WTRU, using the configured HARQ, determines whether or not the packet has been successfully received 175. If the packet has not been successfully received the WTRU may check to see if a maximum number of retransmission attempts has occurred 180.

If the packet has not been successfully received and the maximum number of retransmissions has not occurred, the WTRU sends a NACK 185 and resumes listening for a new HARQ resource allocation 165 to continue the retransmission process. If the packet has been successfully received, or if the maximum number of retransmissions has occurred, the WTRU sends an ACK 190 and resumes listening for an indication of whether the next data to arrive is RT or NRT 105.

A method for handling interactions between measurement gaps, HARQ, and DTX/DRX in a WTRU for uplink communication is now described. A measurement gap may be assigned when there is no active UL traffic or when there is active UL traffic (NRT or RT). It there is no active UL traffic, the measurement gap can be allocated by a Node B based on a WTRU's condition or upon request by the WTRU with no interaction issues to consider.

When there is on-going UL NRT traffic, the start of a measurement gap can be allocated after finishing on-going NRT traffic. When there is on-going UL RT traffic such as persistently-scheduled service, the WTRU may be configured to evaluate whether a predetermined measurement gap duration (e.g., 20 ms) is sufficient to perform a measurement in order to support inter-frequency/inter-RAT mobility. If the duration is sufficient, the WTRU may report to the Node B and the Node B may use the predetermined duration or assign a new measurement gap duration.

If the measurement duration is insufficient or if the WTRU is not allowed to use that duration to perform measurement, the Node B may estimate how long it will take the UL persistently-scheduled service traffic to finish. If there is no indication that the persistently-scheduled service will finish relatively quickly, the Node B can allocate the measurement gaps to the WTRU.

If measurement gaps are allocated when UL persistently-scheduled service traffic is ongoing, the WTRU may not get the ACK/NACK from the eNB during the measurement gap period and therefore may not perform UL retransmissions.

During the measurement gap the WTRU cannot receive any DL traffic from the Node B except when performing inter-frequency and inter-RAT measurement for mobility purpose.

After the measurement gap is assigned, and when a measurement gap is in progress, there are no DL transmissions, so there are no DRX/HARQ interactions. There may be UL transmissions coordinated with DTX such as channel quality index (CQI) reports, and scheduling requests (SRs). If an SR is sent in the UL, the WTRU may wait until the end of the measurement gap to monitor the PDCCH for allocation of UL HARQ configurations. After each measurement gap cycle ends, procedures set forth below for operation in the absence of a measurement gap may be followed.

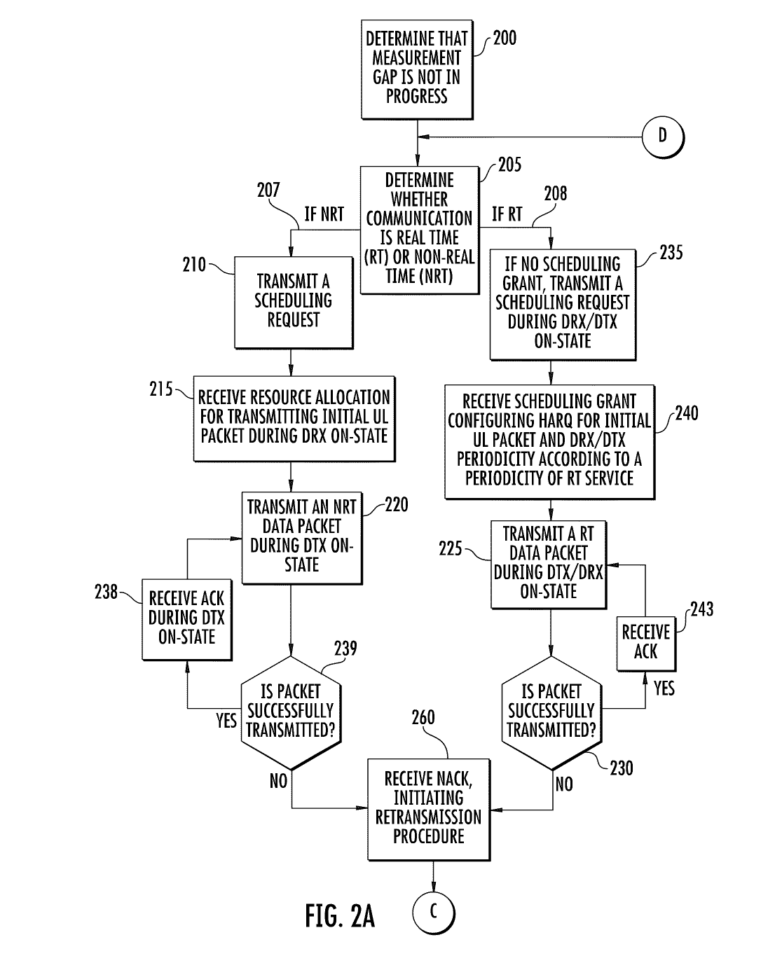

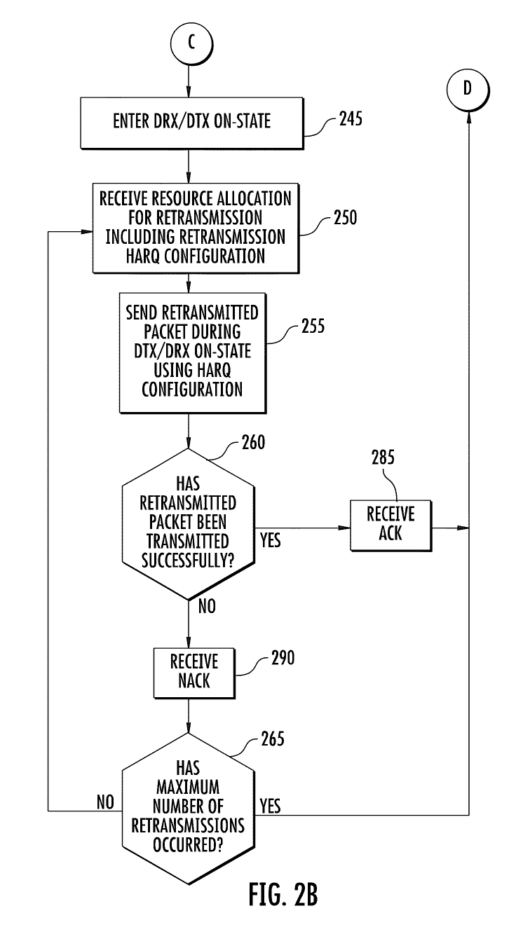

FIGS. 2A and 2B show interaction rules between HARQ and discontinuous reception (DRX) or discontinuous transmission (DTX) in the uplink in the absence of a measurement gap. These interaction rules may be different for RT service and NRT service since the DRX/HARQ operations are different for initial transmission and retransmissions. The WTRU determines that a measurement gap is not in progress 200, as described above. The WTRU determines whether the communication it is about to engage in is RT or NRT, 205.

HARQ and measurement gap interactions in the UL may be handled by the WTRU by a method of corresponding to the alternatives for the DL, described above.

With respect to UL DTX/DRX/HARQ Interaction Operations for Initial Transmission in RT Service, shown in the right branch 208 in FIG. 2A, a WTRU may be configured to check whether there is a scheduling grant or a persistently-scheduled service. If so, the WTRU may transmit on a Physical Uplink Shared Channel (PUSCH). A Node B may not schedule any new data transmission overlapping with HARQ retransmission.

If there is no scheduling grant, the WTRU may transmit an SR during a DTX/DRX off-state 235. The WTRU may use a UL thin channel to transmit the SR. The WTRU may check the status of a buffer containing data to be transmitted. If there is a sufficiently large amount of UL data, the WTRU may be configured to wait for a DTX on-state or, alternatively, to end the current DTX off-state, before transmitting the SR 235. This is possible since the Node B receiver is always on. The WTRU may then force the ending of a current DRX off-state or wait for DRX on-state to listen to the PDCCH for a UL resource allocation. The DTX cycle may implicitly change based on an inactivity timer.

In response to the SR, the WTRU may receive a UL RT scheduling grant 240. If the WTRU detects persistent scheduling from the PDCCH for RT, the WTRU may use information in a resource allocation within the grant to configure its HARQ process for an initial UL RT packet, and to configure HARQ for retransmissions if retransmission is needed. The WTRU may also use information in the resource allocation to configure its DTX according to the periodicity of RT service (e.g. 20 ms for VoIP service) and to configure timers, such as a DTX inactivity timer and a HARQ RTT timer, if such timers are configured in a UL persistent scheduling grant. Once the WTRU is configured by a UL persistent scheduling grant, the WTRU may be configured to enter a DTX/DRX on-state periodically (e.g. 20 ms for Persistently-scheduled service) to transmit a UL RT packet 225.

After the WTRU transmits an UL RT packet, the WTRU may remain in a DTX/DRX on-state in order to detect an ACK/NACK from the Node B and to monitor the PDCCH for resource allocation of UL retransmissions.

Alternatively, the WTRU may go in to a DTX/DRX off-state after transmitting the packet. Then, after a time interval, perhaps lasting milliseconds, it may re-enter the on-state to detect ACK/NACK or receive a UL retransmission resource allocation. The time interval may be set by a HARQ RTT.

If the WTRU detects an ACK 243, the WTRU may transition to short DRX cycle and short DTX cycle and await a new DTX on-duration for subsequent UL RT transmissions 225. If the WTRU detects a NACK 260 then the WTRU may follow the UL retransmission procedures set forth below.

Next to be described are UL DTX/DRX/HARQ interaction rules in NRT service, the left branch 207 in FIG. 2A. These rules may differ somewhat from RT rules since respective DRX and HARQ operations are different for initial transmission and retransmissions.

A channel quality indicator (CQI) may be periodically reported while the WTRU is in a DTX on-state and may be coordinated with a DTX configuration signaled by a Node B to a WTRU. The DTX cycle may implicitly change based on a DTX inactivity timer. If new UL NRT traffic is received several TTIs before the start of a newly configured DTX cycle and UL NRT traffic can be finished before the start of a new DTX off-state, the Node B can allocate UL resource and the WTRU can start to transmit UL NRT traffic. Otherwise, if UL NRT traffic can be finished before the start of new DTX off-state the WTRU can transmit UL NRT traffic when one DTX cycle ends. The UL radio resource allocation can be in the PDCCH before the start of a new DTX on-state or at the end of a DTX off-state duration.

The WTRU may send an SR 210 during a DTX on-state, perhaps using a periodic dedicated UL channel. Alternatively, the WTRU can send SR while ignoring the DTX state if the request is for high priority data—that is, data that must be delivered immediately or with relatively short delay.

The WTRU may forcibly end a current DRX or wait for the next DRX on-state, to monitor the PDCCH and receive from it a UL resource allocation 215 after sending the SR in the UL, depending on the priority of the data.

The WTRU may enter a DTX/DRX on-state to transmit a UL NRT packet 220. After the WTRU transmits a UL NRT packet, the WTRU may remain in this on-state. Alternatively, the WTRU may enter a DTX/DRX off-state for a time interval, perhaps milliseconds in duration, and then return to an on state. In either case the WTRU may detect an ACK 239 from the Node B and monitor the PDCCH for resource allocation for UL retransmission. The time interval may be set by a HARQ RTT.

If the WTRU detects an ACK 238, the WTRU goes to short DTX cycle and waits for the next DTX on-state for potential transmission 220. If the WTRU detects a NACK 260, the WTRU performs a retransmission method which is now described and shown in FIG. 2B.

For both RT and NRT service, after receiving a NACK from a Node-B 260, the WTRU may enter a DTX/DRX on-state 245 and receive a resource allocation and HARQ information for retransmission, perhaps in a DPCCH 250. To enter the on-state the WTRU may force the end of a DTX/DRX off-state. While in the on-state the WTRU may send a retransmitted packet on the UL using the retransmission HARQ configuration 255. A HARQ process for retransmission may also operate during a DTX off state. The WTRU then determines whether or not the packet has been transmitted successfully by receiving either an ACK or a NACK from the Node B 260. If the WTRU receives an ACK 285 it returns for the next indication of RT or NRT 205. If it receives a NACK 290 the WTRU checks to see if a predetermined maximum number of retransmissions has occurred 265. If the maximum number has occurred the WTRU returns for the next indication of RT or NRT 205. If the maximum number has not occurred the WTRU resumes waiting to receive a new resource allocation 250.

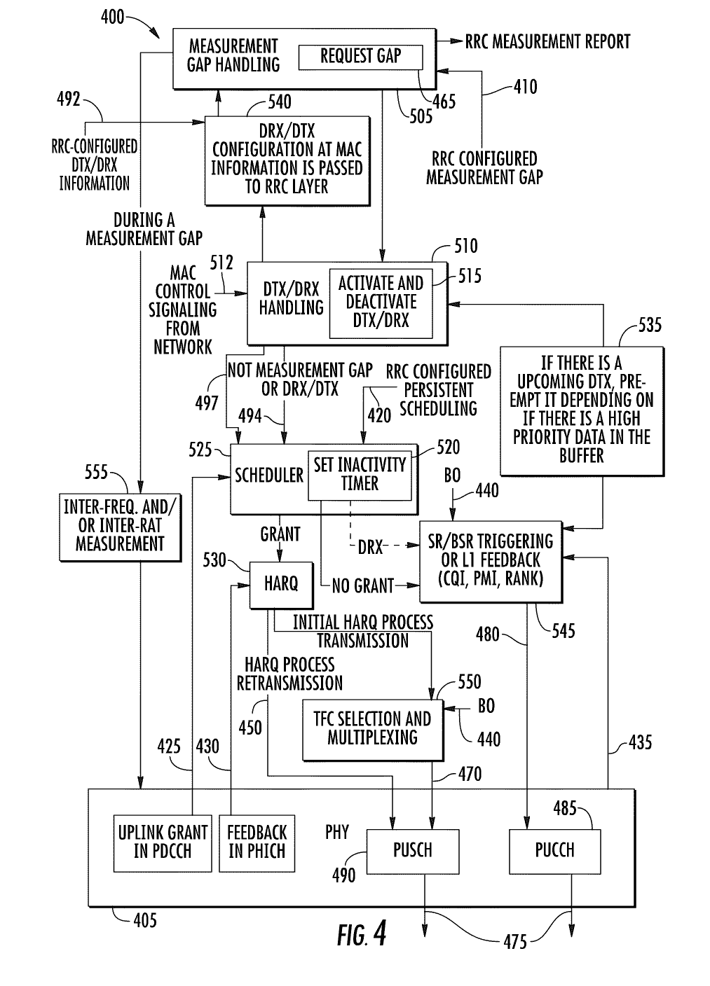

The method described above of handling interactions between measurement gap, HARQ, and DTX/DRX may be implemented by a WTRU containing a Medium Access Control (MAC) entity electrically coupled to a physical layer entity (PHY). An example of an architecture for such MAC and PHY is shown in FIG. 4, where a MAC entity 400 interacts with a PHY layer 405.

During each transmission time interval (TTI), the following MAC functions may be processed in the following order to determine if a transmission from the WTRU will occur and what will be transmitted: Measurement gap verification or request, DTX/DRX activation or deactivation, scheduling grant determination (persistent and semi-persistent (dynamic) for RT and NRT, respectively), HARQ transmission or retransmission, transport format combination (TFC) Selection, Transport Block Multiplexing.

The operation of the architecture of FIG. 4 may be based on the following inputs received by the WTRU: measurement gap information configured by radio resource control (RRC) 410, including when a measurement gap will start and the duration of the measurement gap; DRX cycle information configured by RRC, including when a DRX off-state will start, and how long it will last 492; at least one RRC configured persistent scheduling allocation 420; PDCCH, including an uplink grant 425; physical layer indication channel, including HARQ Feedback 430; L1 (PHY layer) feedback configuration including CQI, preceding matrix indicator (PMI) and rank reporting intervals 435; and a WTRU buffer occupancy (BO) including Radio Link Control (RLC) and Packet Data Convergence Protocol (PDCP) 440.

The operation of the MAC architecture may yield at least one of the following outputs: HARQ operation, including retransmission sequence number and new data indicator (RSN/NDI) and ACK/NACK 450; uplink transmission transport block 470; a start or delay command for DRX 494; request and confirm DRX 497; measurement gap request 465; transmission of Layer 1 (L1) feedback 475; transmission of scheduling request (SR) 480 on a dedicated thin channel, shown as a physical uplink control channel (PUCCH) 485, or on a random access channel (RACH) (not shown); and a buffer status report (BSR), transmitted on the_physical uplink control channel (PUSCH) 490.

The interaction and operation between different sub-entities in the WTRU MAC is shown in FIG. 4, and described as follows.

Measurement gap handling entity 505 receives RRC configured measurement gap information 410. If a measurement gap is in progress, then the WTRU will only perform inter-frequency or inter-RAT measurements for mobility purposes 555. Interaction between HARQ and DTX is possible only when a measurement gap is not in progress. In this situation the MAC entity handles interactions as follows.

DTX/DRX handling entity 510 may determine periods of on-states and off-states of the DTX and DRX cycles based on the RRC configuration 410, received MAC activation/deactivation control signals 512, and an inactivity timer. The DTX/DRX on-state duration may be extended to support ongoing HARQ retransmission in the UL or for a period following a DL PDCCH transmission.

A scheduler 525 may determine allocated resources based on RRC signaled persistent allocations 420 and dynamic grants received on the PDCCH 425. Upon receiving a valid uplink grant 425, scheduler 525 may set the inactivity timer 520 for DRX purpose. Depending on whether an initial transmission or retransmission is in progress, the DTX off-state may be pre-empted 535. If a retransmission is about to start, the DTX off-state may be pre-empted; whereas if an initial transmission is about to start, the DTX off-state may continue. The preemption can be initiated by circuitry triggering an SR or BSR 545. When to end the current DTX/DRX off-state by sending SR and/or BSR, and whether or not to pre-empt the DTX off-state may also be based on whether the data in the UE buffer has high or low priority.

A HARQ entity 530 will perform HARQ related processing with inputs from scheduler 525 and DTX/DRX handling entity 510 and pass HARQ process information to a transport format combination (TFC) selection and multiplexing entity 550.

Information about the DTX/DRX signaling will also be passed by the MAC layer to the RRC layer 540 so that if there is a conflict between DTX/DRX configuration and a gap configuration, the WTRU could ignore the DRX configuration and configure the gap.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of handling interactions with a measurement gap in wireless communications comprising:
defining a fixed number k of transmission time intervals (TTIs), where k≧0; and
completing ongoing hybrid automatic repeat request (HARQ) processing no later than k TTIs before the start of a measurement gap.

2. The method of claim 1, wherein the completing comprises:
saving HARQ data before the measurement gap; and
resuming HARQ processing after the measurement gap ends.

3. The method of claim 1, wherein the completing comprises:
flushing buffered HARQ data and immediately resetting HARQ parameters.

4. The method of claim 1, wherein the completing comprises:
starting a timer; and
upon expiration of the timer, flushing buffered HARQ data and resetting HARQ parameters.

5. A method of handling interactions in wireless communications, comprising:
determining whether or not a measurement gap is in progress;
in response to a determination that the measurement gap is not in progress, receiving in a physical control channel an indication of whether real time (RT) or non-real time (NRT) communication is in effect in the uplink (UL); and
in response to an indication that RT communication is in effect:
transmitting a scheduling request during a discontinuous transmission (DTX) on-state if a scheduling grant has not been received; and
receiving a scheduling grant, the grant configuring HARQ for an initial UL data packet and configuring a periodicity of a discontinuous transmission/discontinuous reception (DTX/DRX) cycle according to a periodicity associated with a persistent scheduling configuration of an RT service.

6. The method of claim 5, further comprising:
in response to the indication that RT communication is in effect, further including:
transmitting a first RT data packet during an on-state of the DTX/DRX cycle;
receiving an indication of whether or not the first RT packet is successfully transmitted;
in response to an indication that the packet is successfully transmitted, transmitting a second RT data packet during an on-state of the DTX/DRX cycle; and
in response to an indication that the packet is not successfully transmitted, starting a retransmission procedure.

7. The method of claim 6, further comprising:
in response to an indication that NRT communication is in effect:
transmitting a scheduling request (SR) while ignoring a state of a (DTX/DRX) cycle;
receiving a resource allocation for transmitting an initial UL data packet during a DTX/DRX on-state;
transmitting a first NRT data packet during a DTX/DRX on-state;
receiving an indication of whether or not the first NRT packet is successfully transmitted;
in response to an indication that the first packet is successfully transmitted; transmitting a second NRT data packet; and
in response to an indication that the first packet is not successfully transmitted, starting the retransmission procedure.

8. The method of claim 7, wherein the receiving a resource allocation occurs after waiting for an on-state of the DTX/DRX cycle.

9. The method of claim 7, wherein the receiving a resource allocation occurs after forcing the DRX cycle from an off-state into an on-state.

10. The method of claim 7, wherein the retransmission procedure comprises:
receiving a retransmission resource allocation including a configuration for retransmission hybrid automatic repeat request (HARQ), the receiving comprising:
entering a DTX/DRX off-state;
remaining in the DTX/DRX off-state for a time interval determined by a HARQ retransmission timer (HARQ RTT);
entering the DTX/DRX on-state after the time interval has elapsed; and
waiting to receive the retransmission resource allocation.

11. The method of claim 10, wherein the retransmission procedure further comprises:
sending a retransmitted packet during a DTX/DRX on-state using the retransmission HARQ configuration;
receiving an indication of whether or not the retransmitted packet is successfully transmitted;
in response to an indication that the retransmitted packet is not successfully transmitted:
returning to the receiving of a retransmission resource allocation if a maximum number of retransmissions has not occurred; and
in response to an indication that the retransmitted packet is successfully transmitted or if the maximum number of retransmissions has occurred:
monitoring the physical control channel for a new indication of whether real time (RT) or non-real time (NRT) communication is in effect.

12. The method of claim 6, wherein the retransmission procedure comprises:
receiving a retransmission resource allocation including a configuration for retransmission hybrid automatic repeat request (HARQ), the receiving comprising:
entering a DTX/DRX off-state;
remaining in the DTX/DRX off-state for a time interval determined by a HARQ retransmission timer (HARQ RTT);
entering the DTX/DRX on-state after the time interval has elapsed; and
waiting to receive the resource allocation.

13. The method of claim 12, wherein the retransmission procedure further comprises:
sending a retransmitted packet during a DTX/DRX on-state using the retransmission HARQ configuration;
receiving an indication of whether or not the retransmitted packet is successfully transmitted;
in response to an indication that the retransmitted packet is not successfully transmitted:
returning to the receiving of a retransmission resource allocation if a maximum number of retransmissions has not occurred; and
in response to an indication that the retransmitted packet is successfully transmitted or if the maximum number of retransmissions has occurred:
monitoring the physical control channel for a new indication of whether real time (RT) or non-real time (NRT) communication is in effect.

14. The method of claim 5, wherein in response to both a determination that the measurement gap is in progress and an indication that RT communication is in effect, the retransmission procedure is not started.

15. A method of handling interactions in wireless communications during the absence of a measurement gap, comprising:
receiving in a physical control channel an indication of whether real time (RT) or non-real time (NRT) communication is in effect in a downlink (DL); and
in response to an indication that RT communication is in effect:
receiving a persistent scheduling grant, the grant:
configuring a discontinuous transmission/discontinuous reception (DTX/DRX) cycle periodicity according to a periodicity associated with a persistent scheduling configuration for the RT communication; and
configuring a timer, the timer being one of an inactivity timer and a HARQ retransmission timer (HARQ RTT).

16. The method of claim 15, further comprising:
in response to the indication that RT communication is in effect, further including:
receiving an RT data packet during an on-state of the DTX/DRX cycle, the on-state occurring with the DTX/DRX cycle periodicity;
determining whether or not the RT data packet is successfully received;
in response to a determination that the RT data packet is successfully received, transmitting an ACK and receiving a new persistent scheduling grant; and
in response to a determination that the RT data packet is not successfully received, transmitting a NACK, thereby starting a retransmission procedure.

17. The method of claim 16, wherein:
in response to an indication that NRT communication is in effect:
receiving a scheduling grant during an on-state of a DTX/DRX cycle;
receiving an NRT data packet during an on-state of the DTX/DRX cycle;
determining whether or not the NRT packet is successfully received;
in response to a determination that the NRT packet is successfully received, transmitting an acknowledgement (ACK) and receiving a new scheduling grant; and
in response to a determination that the NRT packet is not successfully received, transmitting a negative acknowledgement (NACK), thereby starting the retransmission procedure.

18. The method of claim 17, wherein the retransmission procedure comprises:
receiving a HARQ resource allocation, the receiving comprising:
entering a DTX/DRX off-state;
remaining in the DTX/DRX off-state for a time interval determined by a HARQ retransmission timer (HARQ RTT);
entering the DTX/DRX on-state after the time interval has elapsed; and
monitoring the physical control channel for the resource allocation.

19. The method of claim 18, wherein the retransmission procedure further comprises:
receiving a retransmitted packet during a DTX/DRX on-state using HARQ configured using the HARQ resource allocation;
determining whether or not the retransmitted packet has been successfully received;
in response to a determination that the retransmitted packet has not been successfully received and that a maximum number of retransmissions has not occurred:
sending a NACK and returning to the receiving of a resource allocation; and
in response to a determination that the retransmitted packet has been successfully received or that the maximum number of retransmissions has occurred:
sending an ACK and monitoring the physical control channel for a new indication of whether real time (RT) or non-real time (NRT) communication is in effect.

20. The method of claim 16, wherein the retransmission procedure comprises:
receiving a HARQ resource allocation the receiving comprising:
entering the DTX/DRX off-state;
remaining in the DTX/DRX off-state for a time interval determined by a HARQ retransmission timer (HARQ RTT);
entering the DTX/DRX on-state after the time interval has elapsed; and
monitoring the physical control channel for the resource allocation.

21. The method of claim 20, wherein the retransmission procedure further comprises:
receiving a retransmitted packet during a DTX/DRX on-state using the configured HARQ;
determining whether or not the retransmitted packet has been successfully received;
in response to a determination that the retransmitted packet has not been successfully received and that a maximum number of retransmissions has not occurred:
sending a NACK and returning to the receiving of a resource allocation; and
in response to a determination that the retransmitted packet has been successfully received or that the maximum number of retransmissions has occurred:
sending an ACK and monitoring the physical control channel for a new indication of whether real time (RT) or non-real time (NRT) communication is in effect.

22. A wireless transmit/receive unit (WTRU) comprising:
a transceiver, configured to transmit and receive wireless communication signals;
a processor configured to control the transceiver and to implement medium access control (MAC) layer functions;
a buffer configured to store data to be transmitted on an uplink (UL); and
a MAC entity; comprising:
a measurement gap handling entity, configured to receive and process measurement gap configuration information and determine whether or not a measurement gap is in progress;
a discontinuous transmission/discontinuous reception (DTX/DRX) handling entity, configured to:
extend DTX/DRX on-state duration to support ongoing hybrid automatic repeat request (HARQ) retransmission in the UL or for a period following a download (DL) PDCCH transmission; and
a scheduler configured to:
preempt entry into a DTX off-state if:
the buffer contains high priority data, or
a retransmission is about to start;
a HARQ entity, configured to:
receive HARQ feedback information on a physical HARQ indicator channel (PHICH);
receive grant information from the scheduler; and
perform HARQ-related processing based on the HARQ feedback information and the grant information; and
a transport format combination (TFC) selection and multiplexing entity configured to select a TFC based on HARQ process information received from the HARQ entity.

23. The WTRU of claim 22, wherein the DTX/DRX handling entity is further configured to:
receive activation and deactivation control signaling;
determine periods of on-states and off-states of DTX and DRX cycles based on received control signaling, measurement gap information from the measurement gap handling entity, and an inactivity timer; and
pass information about the control signaling to a radio resource control (RRC) layer.

24. The WTRU of claim 22, wherein the scheduler is further configured to:
receive DTX/DRX configuration information from the DTX/DRX handling entity;
receive a persistent allocation and a dynamic uplink grant;
determine allocated resources based on the persistent allocation, the grant, or both; the determined allocated resources including HARQ resources; and
set an inactivity timer for DRX purposes upon receiving the uplink grant.

25. The WTRU of claim 22, wherein the MAC entity is configured to determine if a transmission will occur and what will be transmitted by performing in order:
measurement gap request or verification by the measurement gap handling entity;
DTX/DRX activation or deactivation by the DTX/DRX handling entity;
persistent and dynamic scheduling grant determination by the DTX/DRX handling entity;
HARQ transmission or retransmission by the HARQ entity;
transport format combination (TFC) selection by the TFC selection and multiplexing entity; and
transport block multiplexing.

26. The WTRU of claim 23, wherein the scheduler is configured to receive the uplink grant on a physical downlink control channel (PDCCH).

27. The WTRU of claim 22, wherein the MAC is further configured to operate based on:
feedback from a physical layer; and
occupancy of the buffer.

28. The WTRU of claim 27, wherein the feedback from a physical layer comprises:
a channel quality indicator;
a preceding matrix indicator; and
a rank reporting interval.

29. The WTRU of claim 22, wherein the scheduler is configured to:
receive, in a physical control channel, an indication of whether real time (RT) or non-real time (NRT) communication is in effect in the uplink and in the downlink;
in response to an indication that UL NRT communication is in effect:
transmit a scheduling request (SR) while ignoring a state of a discontinuous transmission/discontinuous reception (DTX/DRX) cycle; and
receive a resource allocation for transmitting an initial UL data packet during a DRX on-state; and
in response to an indication that UL RT communication is in effect:
transmit a scheduling request during a DTX on-state; and
receive a scheduling grant configuring HARQ for an initial UL data packet and DTX/DRX periodicity according to a periodicity of an RT service.

30. The WTRU of claim 29, wherein:
in response to an indication that DL NRT communication is in effect:
receive a scheduling grant during an on-state of the DTX/DRX cycle; and
receive a persistent scheduling grant, the grant:
configuring a DTX/DRX cycle periodicity according to a periodicity associated with a persistent scheduling configuration for the RT communication; and
configuring a timer, the timer being one of an inactivity timer and a HARQ retransmission timer (HARQ RTT).

31. The WTRU of claim 22, wherein the HARQ entity is configured to:
receive, on a physical HARQ indicator channel (PHICH) an indication of whether or not a data packet is successfully transmitted;
in response to an indication that the data packet is not successfully transmitted, start a retransmission procedure;
receive a resource allocation for retransmission from the scheduler; the resource allocation including HARQ configuration; and
receive scheduling grant information from the scheduler.

32. The WTRU of claim 22, wherein the measurement gap handling entity is configured to allow inter-frequency and inter-RAT (radio access technology) measurements while a measurement gap is in progress.
